(19) United States
(12) Patent Application Publication
(10) Pub. No.: US 2025/0091021 A1
(43) Pub. Date: Mar. 20, 2025

(54) PROCESSING DEVICE FOR LITHIUM BATTERY POSITIVE ELECTRODE MATERIAL

(71) Applicants: GUANGDONG BRUNP RECYCLING TECHNOLOGY CO., LTD., Guangdong (CN); HUNAN BRUNP RECYCLING TECHNOLOGY CO., LTD., Hunan (CN)

(72) Inventors: Haijun YU, Guangdong (CN); Yinghao XIE, Guangdong (CN); Aixia LI, Guangdong (CN); Xuemei ZHANG, Guangdong (CN); Changdong LI, Guangdong (CN)

(73) Assignees: GUANGDONG BRUNP RECYCLING TECHNOLOGY CO., LTD., Guangdong (CN); HUNAN BRUNP RECYCLING TECHNOLOGY CO., LTD., Hunan (CN)

(21) Appl. No.: 18/558,252

(22) PCT Filed: Jul. 15, 2022
(86) PCT No.: PCT/CN2022/106003

§ 371 Date: Oct. 31, 2023

(30) Foreign Application Priority Data
May 19, 2022 (CN) 202210556124.2

(51) Int. Cl. B01F 29/64; B01F 35/12; B01F 35/32; B01F 35/71

(52) U.S. Cl. CPC B01F 29/64; B01F 35/123; B01F 35/322; B01F 35/71775

(57) ABSTRACT

Disclosed is a processing device for a lithium battery positive electrode material, including a base, where the base is fixedly provided with barrel bodies by means of a support, a sleeve is rotatably clamped between the two barrel bodies, a stirring assembly transversely penetrates through interiors of the barrel bodies and the sleeve, the base is further provided with a power mechanism, and the power mechanism separately drives the sleeve and the stirring assembly to rotate. Due to the cooperation of the barrel bodies, the sleeve and the stirring assembly, the stirring assembly can effectively scrape attachments on the inner walls of the barrel bodies, and a first stirring blade in the sleeve and a second stirring blade in the stirring assembly are cooperated to stir, gather and further disperse and disarrange the material, such that the material can be mixed more uniformly.

### TECHNICAL FIELD

The present invention relates to the technical field of battery material processing, and more particularly, to a processing device for a lithium battery positive electrode material.

### BACKGROUND

In the traditional art, a positive electrode material for a lithium battery is generally prepared by solid-phase synthesis. The process is simple and the manufacturing conditions are easy to control. For example, a positive electrode material is prepared by mixing various particle raw materials in a proportion and calcining the obtained mixture at a high temperature for several hours by means of solid-phase thermal synthesis.

When the positive electrode material for the existing lithium battery is subjected to a mixing process, uneven mixing occurs, which seriously affect the quality of the lithium battery. Besides, a large amount of attachments are left on an inner wall of a mixing device.

### SUMMARY

The present invention aims to solve the problems in the background art and provides a processing device for a lithium battery positive electrode material.

The objective of the present invention can be achieved by the following technical solutions:

A processing device for a lithium battery positive electrode material, including a base, where the base is fixedly provided with barrel bodies by means of a support, a sleeve is rotatably clamped between the two barrel bodies, a stirring assembly transversely penetrates through interiors of the barrel bodies and the sleeve, the base is further provided with a power mechanism, and the power mechanism separately drives the sleeve and the stirring assembly to rotate.

As a further solution of the present invention, the power mechanism includes a driving part, a third gear and a transmission belt, and an output end of the driving part is separately connected with the third gear and the transmission belt.

As a further solution of the present invention, the stirring assembly includes a rotating rod and a second stirring blade, the second stirring blade is fixedly arranged on a rod body of the rotating rod, and one end of the transmission belt is sleeved on the rotating rod.

As a further solution of the present invention, a gear ring is fixedly arranged on an outer wall of the sleeve, and the third gear meshes with the gear ring.

As a further solution of the present invention, a first stirring blade is fixedly arranged on an inner wall of the sleeve, a discharge port is further defined in the sleeve, and a hatch cover is mounted on the discharge port.

As a further solution of the present invention, an arc-shaped cavity located at the discharge port is formed in a wall of the sleeve, the arc-shaped cavity communicates with the discharge port, a guide rod is further fixedly arranged in the arc-shaped cavity, the hatch cover slides in the arc-shaped cavity by means of the guide rod, and a spring is further sleeved on the guide rod.

As a further solution of the present invention, the base is provided with an opening assembly located under the sleeve, the opening assembly includes a bracket, a vertical plate and an elastic member, the vertical plate is rotatably connected to the bracket by means of a rotating shaft fixedly arranged at an end of the vertical plate, the elastic member is further arranged between the vertical plate and the bracket, and a convex protrusion is further formed on an outer surface of the hatch cover.

As a further solution of the present invention, the first stirring blade is “V” or “U”-shaped.

As a further solution of the present invention, each of the barrel bodies is further provided with a feeding mechanism, the feeding mechanism includes a box body and a screw rod, the screw rod rotates in the box body, a second gear is fixedly arranged at an end of the screw rod, a first gear is fixedly arranged on the rotating rod, and the second gear meshes with the first gear.

As a further solution of the present invention, the second stirring blade is arc-shaped and corresponds to a radian of inner walls of the barrel bodies.

A method for using a processing device for a lithium battery positive electrode material, comprising the following steps:
S1: loading a material into box bodies by the staff;
S2: turning on a motor by using a controller by the staff, where the motor rotates clockwise, an output shaft of the motor will drive a rotating rod in a stirring assembly to rotate by means of a transmission belt, when the rotating rod rotates, the first gear will drive screw rod to rotate clockwise by means of the second gear, and the material in the box bodies will be discharged into barrel bodies due to the rotation of the screw rods and will be stirred and mixed by the stirring assembly; and
S3: controlling the motor again by the staff by using the controller, where when the motor rotates counterclockwise, the screw rods will also rotate counterclockwise, the material in the box bodies will be blocked, two second stirring blades are symmetrically arranged to form a V-shaped structure with a large opening at a top and a small opening at a bottom, when stirred by the second stirring blades, the material will enter from the large opening of the V-shaped structure and be discharged from the small opening, the material gathers at a position of a sleeve and is contacted by the V-shaped first stirring blades to be separated to both sides to the barrel bodies, and the operation is repeated.

Beneficial effects of the present invention: due to the cooperation of the barrel bodies, the sleeve and the stirring assembly, the stirring assembly can effectively scrape attachments on the inner walls of the barrel bodies, and first stirring blades in the sleeve and second stirring blades in the stirring assembly are cooperated to stir, gather and further disperse and disarrange the material, such that the material can be mixed more uniformly.

### BRIEF DESCRIPTION OF DRAWINGS

The present invention will be further described below in conjunction with the drawings.

FIG. 1 is a schematic structural diagram of the present invention;

FIG. 2 is a schematic diagram of the cross-section structure of the present invention;

FIG. 3 is a structural schematic diagram of the barrel bodies and sleeve in the present invention;

FIG. 4 is a structural schematic diagram of the stirring assembly in the present invention;

FIG. 5 is a schematic structural diagram of the sleeve in the present invention; and

FIG. 6 is a schematic structural diagram of the opening assembly in the present invention.

In the figures: 1, Base; 2, Barrel Body; 3, Sleeve; 31, First Stirring Blade; 32, Gear Ring; 33, Discharge Port; 34, Hatch Cover; 341, Protrusion; 35, Guide Rod; 36, Spring; 4, Feeding Mechanism; 41, Box Body; 42, Screw Rod; 5, Stirring Assembly; 51, Rotating Rod; 52, First Gear; 53, Second Stirring Blade; 6, Power Mechanism; 61, Driving Part; 62, Third Gear; 63, Transmission Belt; 7, Opening Assembly; 71, Bracket; 72, Vertical Plate; 73, Elastic Member; and 74, Rotating Shaft.

### DETAILED DESCRIPTION

The technical solutions in the embodiments of the present invention will be clearly and completely described below with reference to the drawings in the embodiments of the present invention. Apparently, the described embodiments are merely a part rather than all of the embodiments of the present invention. All other embodiments obtained by those ordinarily skilled in the art based on the embodiments of the present invention without creative efforts should also fall within the protection scope of the present invention.

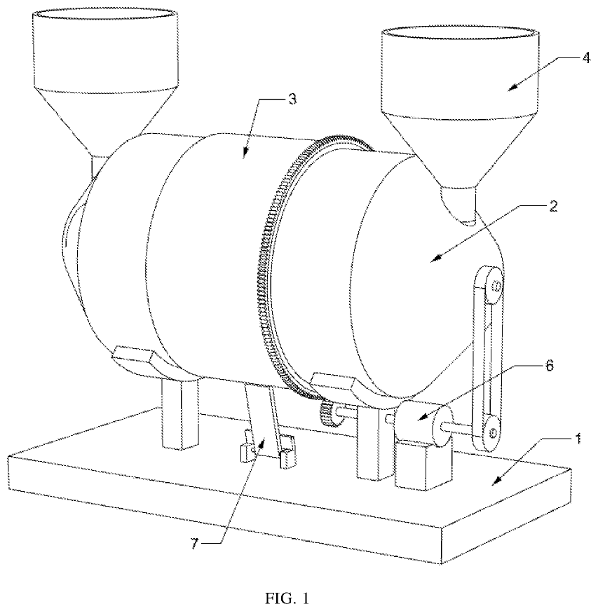

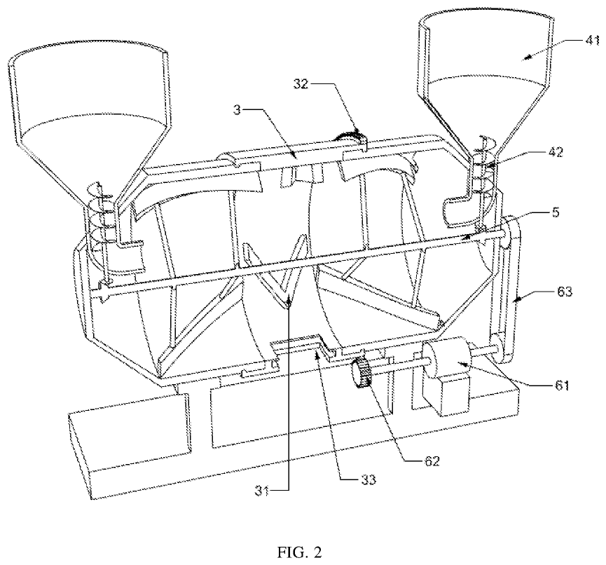

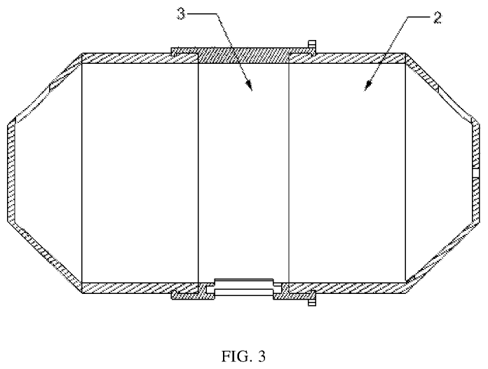

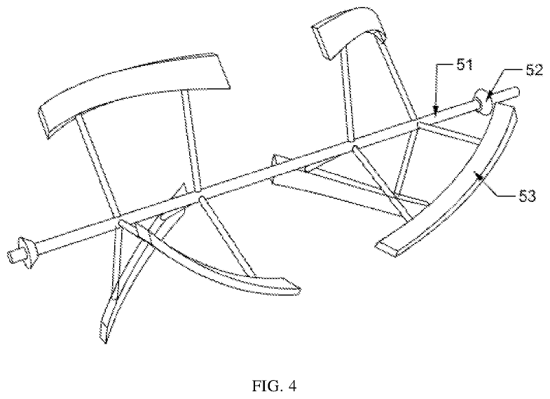

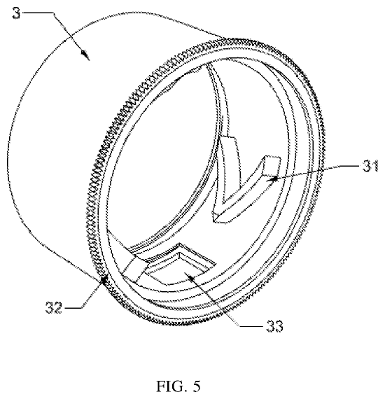

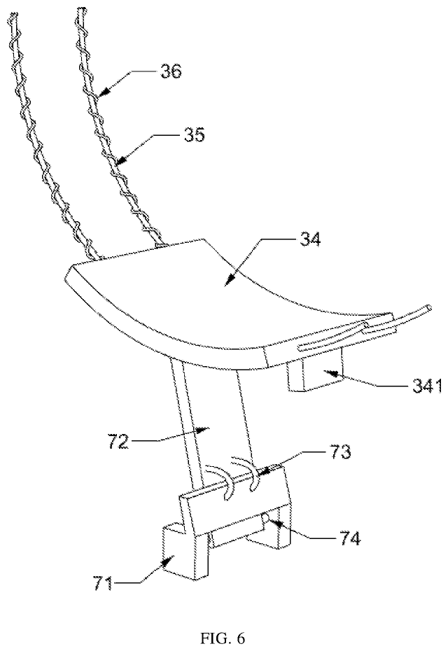

Referring to FIGS. 1-6, the present invention discloses a processing device for a lithium battery positive electrode material. The processing device includes a base 1, the base 1 is fixedly provided with two barrel bodies 2 through a support, and a sleeve 3 is rotatably clamped between the two barrel bodies 2.

The sleeve 3 can rotate with the clamping of the two barrel bodies 2.

The sleeve 3 is annular.

A first stirring blade 31 are fixedly arranged on an inner wall of the sleeve 3.

The first stirring blade 31 is “V”-shaped.

The first stirring blade 31 may further be “U”-shaped.

A discharge port 33 is further defined in the sleeve 3, and a hatch cover 34 is mounted on the discharge port 33.

The discharge port 33 is internally provided with a sliding chute and the hatch cover 34 slides in the sliding chute to open or close the discharge port 33.

A stirring assembly 5 transversely penetrates through interiors of the barrel bodies 2 and the sleeve 3.

The stirring assembly 5 is used for stirring and mixing the material.

The stirring assembly 5 includes a rotating rod 51 and a second stirring blade 53, and the second stirring blade 53 is fixedly arranged on a rod body of the rotating rod 51. The second stirring blade 53 is arc-shaped and correspond to a radian of the barrel bodies 2.

The base 1 is further provided with a power mechanism 6, and the power mechanism 6 separately drives the sleeve 3 and the stirring assembly 5 to rotate.

The power mechanism 6 includes a driving part 61, a third gear 62 and a transmission belt 63, and an output end of the driving part 61 is separately connected with the third gear 62 and the transmission belt 63.

The third gear 62 is fixedly arranged on an output shaft of the driving part 61.

The driving part 61 is a double-shaft motor.

The driving part 61 may further be a stepping motor.

Two stepping motors may be provided.

One end of the transmission belt 63 is sleeved on the rotating rod 51, and the other end of the transmission belt 63 is sleeved on the output shaft of the driving part 61.

A gear ring 32 is fixedly arranged on an outer wall of the sleeve 3, and the third gear 62 meshes with the gear ring 32.

When the driving part 61 rotates, the rotating rod 51 will be driven to rotate by means of the transmission belt 63, and at the same time, the third gear 62 meshes with the gear ring 32 to drive the sleeve 3 to rotate on the barrel bodies 2.

Embodiment 2, disclosed is a processing device for a lithium battery positive electrode material, including a base 1, where the base 1 is fixedly provided with barrel bodies 2 by means of a support, and a sleeve 3 is rotatably clamped between the two barrel bodies 2.

The sleeve 3 can rotate with the clamping of the two barrel bodies 2.

The sleeve 3 is annular.

A first stirring blade 31 is fixedly arranged on an inner wall of the sleeve 3.

The first stirring blade 31 is “V”-shaped.

The first stirring blade 31 may further be “U”-shaped.

A discharge port 33 is further defined in the sleeve 3, and a hatch cover 34 is mounted on the discharge port 33.

The discharge port 33 is internally provided with a sliding chute, and the hatch cover 34 slides in the sliding chute to open or close the discharge port 33.

A stirring assembly 5 transversely penetrates through interiors of the barrel bodies 2 and the sleeve 3.

The stirring assembly 5 is used for stirring and mixing the material.

The stirring assembly 5 includes a rotating rod 51 and a second stirring blade 53, and the second stirring blade 53 is fixedly arranged on a rod body of the rotating rod 51.

The second stirring blade 53 is arc-shaped and corresponds to a radian of the barrel bodies 2.

The base 1 is further provided with a power mechanism 6, and the power mechanism 6 separately drives the sleeve 3 and the stirring assembly 5 to rotate.

The power mechanism 6 includes a driving part 61, a third gear 62 and a transmission belt 63, and an output end of the driving part 61 is separately connected with the third gear 62 and the transmission belt 63.

The third gear 62 is fixedly arranged on an output shaft of the driving part 61.

The driving part 61 is a double-shaft motor.

The driving part 61 may further be a stepping motor.

Two stepping motors may be provided, and output ends of the two stepping motors are separately connected with the third gear 62 and the transmission belt 63.

One end of the transmission belt 63 is sleeved on the rotating rod 51, and the other end of the transmission belt 63 is sleeved on the output shaft of the driving part 61.

A gear ring 32 is fixedly arranged on an outer wall of the sleeve 3 and the third gear 62 meshes with the gear ring 32.

When the driving part 61 rotates, the rotating rod 51 will be driven to rotate by means of the transmission belt 63, and at the same time, the third gear 62 meshes with the gear ring 32 to drive the sleeve 3 to rotate on the barrel bodies 2.

Each of the barrel bodies 2 is further provided with a feeding mechanism 4, the feeding mechanism 4 includes a box body 41 and a screw rod 42, the screw rod 42 penetrates through the box body 41 to rotate, a second gear is fixedly arranged at an end of the screw rod 42, a first gear 52 is fixedly arranged on the rotating rod 51, and the second gear meshes with the first gear 52.

The first gear 52 and the second gear are all bevel gears.

A discharge pipe is formed at a bottom part of the box body 41, and the screw rod 42 specifically rotates in the discharge pipe at the bottom part of the box body 41.

The box body 41 is specifically fixedly arranged on the barrel bodies 2.

A specific operation method is as follows:

An external controller is required to control the device.

When a driving part 61 is a double-shaft motor or a single stepping motor: the material is loaded into box bodies 41, the driving part 61 is turned on by the staff by using a controller, the driving part 61 rotates clockwise, an output shaft of the driving part 61 will drive a rotating rod 51 in a stirring assembly 5 to rotate by means of a transmission belt 63, when the rotating rod 51 rotates, the first gear 52 will drive the screw rod 42 to rotate clockwise by means of second gears, and the material in the box bodies 41 will be discharged into barrel bodies 2 due to the rotation of the screw rods 42 and will be stirred and mixed by the stirring assembly 5. The driving part 61 is controlled again by the staff by using the controller, when the driving part 61 rotates counterclockwise, the screw rods 42 will also rotate counterclockwise, and the material in the box bodies 41 will be blocked.

When two stepping motors are provided on the driving part 61: an output end of one stepping motor is connected to a third gear 62, an output end of the other stepping motor is connected to a transmission belt 63, and the controller separately controls the two stepping motors.

A state of a material in barrel bodies 2 during a stirring process is as follows:

Two second stirring blades 53 are symmetrically arranged to form a V-shaped structure with a large opening at a top and a small opening at a bottom, when stirred by the second stirring blades 53, the material will enter from the large opening of the V-shaped structure and be discharged from the small opening, the material gathers at a position of a sleeve 3 and is contacted by the V-shaped first stirring blades 31 to be separated to both sides to the barrel bodies 2, and the operation is repeated.

Embodiment 3, on the basis of embodiment 1 or 2, an arc-shaped cavity is formed inside the sleeve 3 at a discharge port 33.

The arc-shaped cavity communicates with the discharge port 33.

A guide rod 35 is further fixedly arranged in the arc-shaped cavity.

A radian of the guide rod 35 is the same as that of the arc-shaped cavity.

The hatch cover 34 slides in the arc-shaped cavity by means of the guide rod 35.

A spring 36 further sleeved on the guide rod 35.

The spring 36 is specifically compression spring.

The base 1 is provided with an opening assembly 7 located under the sleeve 3, the opening assembly 7 includes a bracket 71, a vertical plate 72 and an elastic member 73, the vertical plate 72 is rotatably connected to the bracket 71 by means of a rotating shaft 74 fixedly arranged at an end of the vertical plate, and the elastic member 73 is further arranged between the vertical plate 72 and the bracket 71.

The elastic member 73 may be a return spring, a tension spring, etc.

A convex protrusion 341 is further formed on an outer surface of the hatch cover 34.

The vertical plate 72 will contact with the convex protrusion 341.

When the hatch cover 34 in the sleeve 3 rotates clockwise to the opening assembly 7, the protrusion 341 of the hatch cover 34 will contact with the vertical plate 72, the vertical plate 72 will be blocked by the bracket 71, the vertical plate 72 will apply a force on the hatch cover 34 by means of the protrusion 341, such that the hatch cover 34 will slide in the arc-shaped cavity, the hatch cover 34 will be opened, and the spring 36 will be deformed.

When the hatch cover 34 in the sleeve 3 rotates counterclockwise to the opening assembly 7, the protrusion 341 of the hatch cover 34 will contact with the vertical plate 72, the vertical plate 72 will rotate around an axis of the rotating shaft 74, and the elastic member 73 will be deformed under a force.

One embodiment of the present invention is described above in detail, which is merely a preferred embodiment of the present invention and cannot be construed as limiting the scope of implementation of the present invention. Any equivalent modifications, improvements, etc. made within the application scope of the present invention should fall within the protection scope of the present invention.

1. A processing device for a lithium battery positive electrode material, comprising a base (1), wherein the base (1) is fixedly provided with barrel bodies (2) by means of a support, a sleeve (3) is rotatably clamped between two of the barrel bodies (2), a stirring assembly (5) transversely penetrates through interiors of the barrel bodies (2) and the sleeve (3), the base (1) is further provided with a power mechanism (6), and the power mechanism (6) is configured to drive the sleeve (3) and the stirring assembly (5) to rotate.

2. The processing device of claim 1, wherein the power mechanism (6) comprises a driving part (61), a third gear (62) and a transmission belt (63), and an output end of the driving part (61) is separately connected with the third gear (62) and the transmission belt (63).

3. The processing device of claim 2, wherein the stirring assembly (5) comprises a rotating rod (51) and a second stirring blade (53), the second stirring blade (53) is fixedly arranged on a rod body of the rotating rod (51), and one end of the transmission belt (63) is sleeved on the rotating rod (51).

4. The processing device of claim 2, wherein a gear ring (32) is fixedly arranged on an outer wall of the sleeve (3), and the third gear (62) meshes with the gear ring (32).

5. The processing device of claim 4, wherein a first stirring blade (31) is fixedly arranged on an inner wall of the sleeve (3), a discharge port (33) is further arranged in the sleeve (3), and a hatch cover (34) is mounted on the discharge port (33).

6. The processing device of claim 5, wherein an arc-shaped cavity located at the discharge port (33) is formed in a wall of the sleeve (3), the arc-shaped cavity communicates with the discharge port (33), a guide rod (35) is further fixedly arranged in the arc-shaped cavity, the hatch cover (34) slides in the arc-shaped cavity by means of the guide rod (35), and a spring (36) is further sleeved on the guide rod (35).

7. The processing device of claim 6, wherein the base (1) is provided with an opening assembly (7) located under the sleeve (3), the opening assembly (7) comprises a bracket (71), a vertical plate (72) and an elastic member (73), the vertical plate (72) is rotatably connected to the bracket (71) by means of a rotating shaft (74) fixedly arranged at an end of the vertical plate (72), the elastic member (73) is further arranged between the vertical plate (72) and the bracket (71), and a convex protrusion (341) is further formed on an outer surface of the hatch cover (34).

8. The processing device of claim 5, wherein the first stirring blade (31) is “V” or “U”-shaped.

9. The processing device of claim 3, wherein each of the barrel bodies (2) is further provided with a feeding mechanism (4), the feeding mechanism (4) comprises a box body (41) and a screw rod (42), the screw rod (42) rotates in the box body (41), a second gear is fixedly arranged at an end of the screw rod (42), a first gear (52) is fixedly arranged on the rotating rod (51), and the second gear meshes with the first gear (52).

10. The processing device of claim 3, wherein the second stirring blade (53) is arc-shaped and corresponds to a radian of inner walls of the barrel bodies (2).

11. The processing device of claim 3, wherein a gear ring (32) is fixedly arranged on an outer wall of the sleeve (3), and the third gear (62) meshes with the gear ring (32).
